(19) United States
(12) Patent Application Publication
(10) Pub. No.: US 2019/0047129 A1
(43) Pub. Date: Feb. 14, 2019

(54) COMBUSTION CHAMBER AND DRIVE-IN DEVICE

(71) Applicant: HILTI AKTIENGESELLSCHAFT, Schaan (LI)

(72) Inventors: Thomas SPERRFECHTER, Grüsch (CH); Thorsten BARTZ, Walenstadt (CH); Peter STAUSS-REINER, Feldkirch (AT); David MEIER, Igis (CH)

(73) Assignee: Hilti Aktiengesellschaft, Schaan (LI)

(21) Appl. No.: 16/073,369

(22) PCT Filed: Jan. 31, 2017
(86) PCT No.: PCT/EP2017/051964

§ 371 Date: Jul. 27, 2018

(30) Foreign Application Priority Data
Feb. 1, 2016 (EP) 16153619.8

(51) Int. Cl. B25C 1/08

(52) U.S. Cl. CPC B25C 1/08; B25C 1/008

(57) ABSTRACT

A combustion chamber has a combustion chamber wall formed as a hollow cylinder defining a cylinder axis, a bottom that is adjustable along the cylinder axis within the hollow cylinder, relative to the combustion chamber wall, and a seal, which lies against the bottom on the one side and against the combustion chamber wall on the other side, in a radial direction with reference to the cylinder axis. The seal comprises a first seal ring extending in the circumferential direction with reference to the cylinder axis and has a first interruption, and a second seal ring extending in the circumferential direction with reference to the cylinder axis and has a second interruption. The first interruption has a first angular position along the circumferential direction, and the second interruption has a second angular position along the circumferential direction, wherein the first angular position and the second angular position form an angle.

The invention relates to a combustion chamber and to a fastener driving tool having such a combustion chamber.

Combustion chambers, in particular of fastener driving tools, are known, which comprise a combustion chamber wall in the form of a hollow cylinder that defines a cylinder axis, a bottom that is adjustable within the hollow cylinder, relative to the combustion chamber wall, along the cylinder axis, and a seal, which lies against the bottom on the one side and against the combustion chamber wall on the other side, in a radial direction with reference to the cylinder axis, for example in order to seal a gap between the bottom and the combustion chamber wall. The sealing effect is usually achieved in that the seal consists of a soft sealant, for example of an elastomer.

A sealing effect can also be brought about when using a hard sealant, for example a thermoplastic or a duroplastic, or also a metal or an alloy, in that the seal can be moved with shape elasticity, in other words on the basis of its external shape. For example, the seal comprises a first seal ring that extends in the circumferential direction with reference to the cylinder axis and has a first interruption. Because of the interruption, the rigidity of the seal ring as such is reduced, so that the seal ring as a whole lies against the combustion chamber wall, for example, in elastic manner. In order to minimize leakage that is connected with the interruption, it is known to use a second seal ring having a second interruption, which ring extends in the circumferential direction with reference to the cylinder axis, which interruption is disposed along the circumferential direction relative to the first interruption. The opposite placement of the first and the second interruption is fixed in place by means of a fixation apparatus.

The use of two seal rings proves to be disadvantageous, however, if the combustion chamber is stored at temperatures below the freezing point of water, so that moisture that might be present between the two seal rings can freeze. The seal rings then freeze onto one another and reciprocally make their shape rigid, so that it is possible for the bottom to become jammed relative to the combustion chamber wall. The ice that connects the two seal rings with one another must then first be broken up after such storage in order to be able to use the combustion chamber, and this is not possible without prior warming, or only with very great expenditure of force.

DE 102 26 878 A1 describes a fastener driving tool for driving a nail into a work piece, in which tool a combustion chamber is charged with a combustion gas, wherein a driving piston is accelerated against the nail after an ignition process. The combustion chamber has an adjustable combustion chamber bottom, wherein an adjusting rod is passed through a housing of the combustion chamber by means of a passage and connected with the adjustable combustion chamber bottom. The combustion chamber bottom is sealed relative to the combustion chamber wall by a circumferential seal.

It is the task of the invention to indicate a combustion chamber as well as a fastener driving tool, which allow reliable operation, in particular also at low ambient temperatures.

This task is accomplished, in the case of a combustion chamber in which the first interruption has a first angular position along the circumferential direction, and the second interruption has a second angular position along the circumferential direction, wherein the first angular position and the second angular position form an angle that is greater than 0° and less than 180°. The invention is based on the recognition that when the first and the second seal ring freeze onto one another, it is not necessary to break up the ice that connects the two seal rings over the entire circumference of the seal rings. Instead, it is sufficient to break up the ice over a single circumference section between the first and the second interruption, so that the two interruptions are movable relative to one another. The reciprocal reinforcement of the two seal rings has then essentially already been cancelled out. Shortening of a single circumference section between the two interruptions is sufficient for ensuring a weak point in the undesirable ice formation between the two seal rings, so that breaking up the ice is facilitated or made possible.

In an advantageous embodiment, the combustion chamber wall has the shape of a hollow circular cylinder. Other cylinder shapes are also advantageous, under some circumstances, wherein the cylinder axis then runs through the center of gravity of the footprint of the cylinder.

In an advantageous embodiment, the first angular position and the second angular position form an angle that is less than 120°, preferably less than 90°, particularly preferably less than 60°. It is also advantageous if the first angular position and the second angular position form an angle that is greater than 30°.

In an advantageous embodiment, the second seal ring follows the first seal ring in an axial direction with reference to the cylinder axis. Preferably, the second seal ring lies against the first seal ring with its entire surface, particularly preferably over the entire circumference except for the first and the second interruption.

In an advantageous embodiment, the seal has a fixation apparatus for fixing the angle formed by the first and the second angular position in place. Preferably, the fixation apparatus comprises a projection on the first seal ring and a recess on the second seal ring, wherein the projection projects into the recess.

In an advantageous embodiment, the first and/or the second seal ring consist(s) of a hard sealant. Preferably, the sealant comprises a hard plastic, particularly preferably one that is reinforced with fibers, for example a duroplastic or a thermoplastic, or a metal or an alloy. Soft sealing materials such as elastomers or rubber or silicone are to be distinguished from the former; when used as a seal, they are deformed in and of themselves due to their material elasticity, in order to achieve a sufficient sealing effect.

In an advantageous embodiment, the bottom has a groove that runs in the circumferential direction, into which groove the first and/or the second seal ring projects.

In an advantageous embodiment, the combustion chamber comprises an elastic support element, which is disposed between the bottom and the seal, preferably in the groove that might be present in the radial direction, and which biases the first and/or the second seal ring against the combustion chamber wall. Preferably, the support element is material-elastic, for example consisting of an elastomer, or shape-elastic, for example configured as a spring plate. The support element is preferably configured as a circumferential ring. Also preferably, the support element consists of multiple individual elastic members.

In an advantageous embodiment, the bottom can be adjusted relative to the combustion chamber wall, in an axial direction with reference to the cylinder axis, to such an extent that an inlet and/or outlet opening of the combustion chamber forms between the bottom and the combustion chamber wall.

In an advantageous embodiment, the combustion chamber is used in a fastener driving tool that has a driving piston for driving a fastening element into a work piece, wherein a propellant for driving the driving piston can be combusted in the combustion chamber.

In an advantageous embodiment, the fastener driving tool has a housing, and the combustion chamber wall is rigidly connected with the housing. The bottom then represents a movable part in the fastener driving tool. In a further advantageous embodiment, the fastener driving tool has a housing, and the bottom is rigidly connected with the housing. The combustion chamber wall then represents a moving part in the fastener driving tool.

The bottom of the combustion chamber, which is adjustable relative to the combustion chamber wall, makes it possible, in general, for the combustion chamber to be collapsed, for example as part of a safety device, if the tool is not properly set onto a work piece. In the case of such tools, the combustion chamber is stretched out before every setting process, by being set down, so that the combustion chamber wall is slipped on, in each instance.

In an advantageous embodiment, a recess for conducting away the water stripped off by the seal is disposed on the combustion chamber bottom and/or on the combustion chamber wall, in order to conduct water away. This allows water condensed on the combustion chamber wall to be conducted away, so that under some circumstances, less ice forms between the first and the second seal ring.

Further advantages and characteristics of the invention are evident from the exemplary embodiments described below, as well as from the dependent claims.

In the following, a preferred exemplary embodiment of the invention will be described and explained in greater detail using the attached drawings.

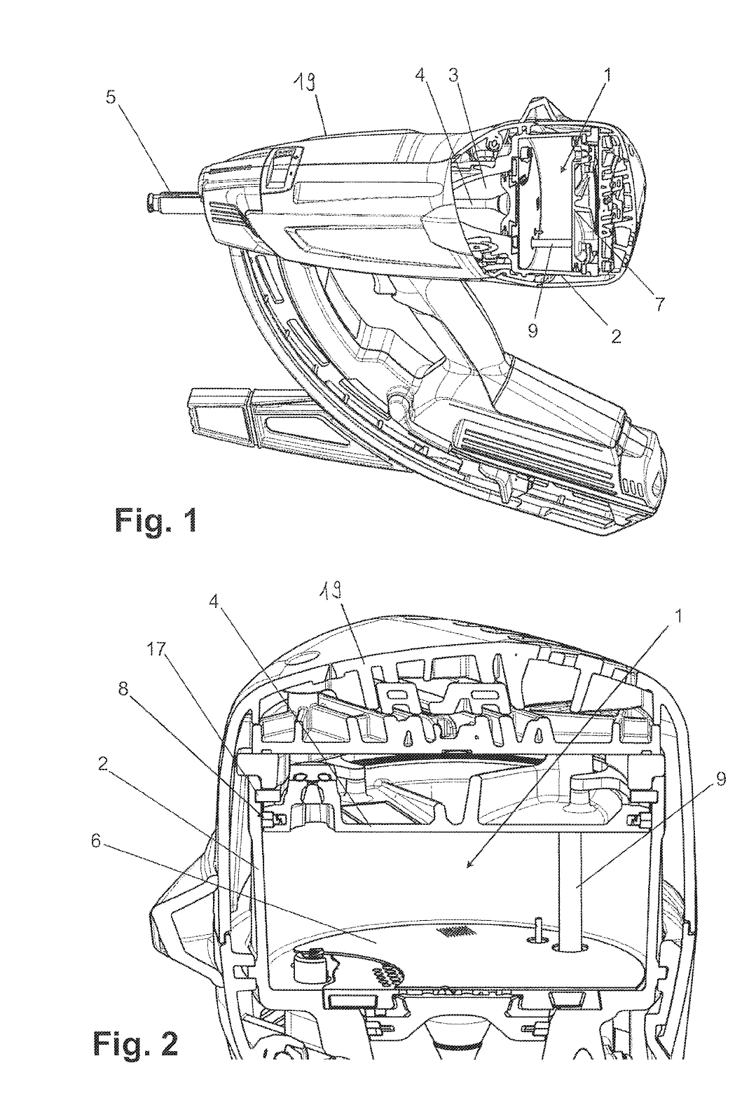

FIG. 1 shows a spatial overall view of a fastener driving tool, with the combustion chamber in section.

FIG. 2 shows a detail enlargement of the combustion chamber from FIG. 1.

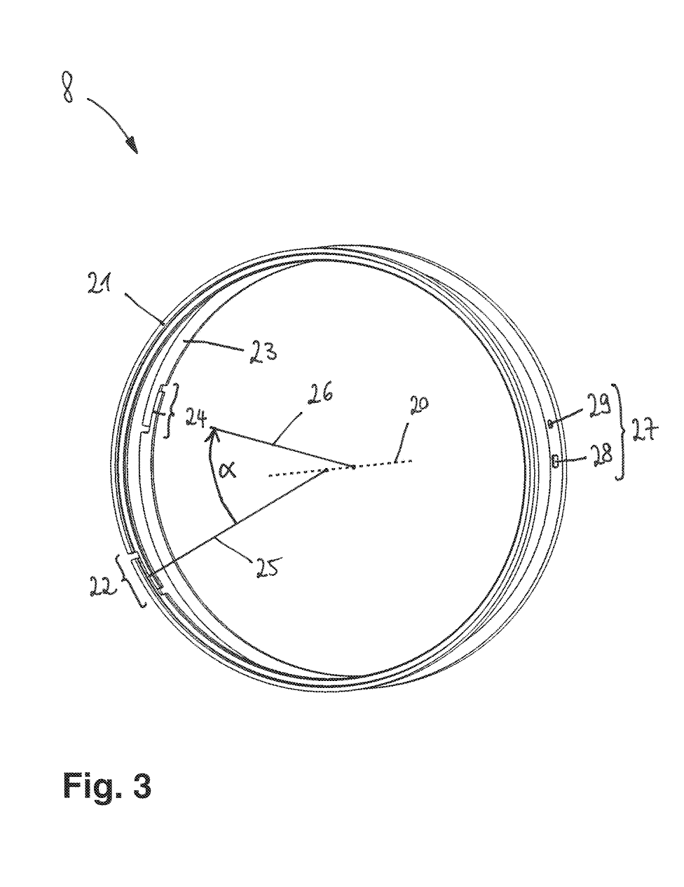

FIG. 3 is an exploded drawing of a seal for a combustion chamber.

The fastener driving tool from FIG. 1 is a hand-held tool, comprising a housing 19 as well as a combustion chamber 1 having a combustion chamber wall 2, which is cylindrical in certain sections and rigidly connected with the housing 19. The combustion chamber 1 is followed by a cylinder 3 having a driving piston 4 guided in it. A safety mechanism of the tool comprises a set-down sleeve 5, which is set onto a work piece (not shown) and pressed in counter to the pressure of a spring. Only in this state can a driving process be triggered in the combustion chamber by means of ignition of a propellant in the form of a combustion gas. A swirl plate 6 is furthermore disposed in the combustion chamber 1, which plate can be moved through the combustion chamber 1 before ignition.

A bottom 7 of the combustion chamber 1 can be moved along an axis that coincides with the driving direction, so that the volume of the combustion chamber can be changed. For this purpose, the bottom 7 is sealed off relative to the cylindrical combustion chamber wall 2 with a circumferential seal 8. In FIGS. 1 and 2, the seal 8 is shown only schematically. A detail of the configuration of the seal 8 according to the invention is shown in detail in FIG. 3.

In exemplary embodiments that are not shown, the bottom is rigidly connected with the housing, and the combustion chamber wall is configured as an axially movable sleeve. In exemplary embodiments that are also not shown, the combustion chamber wall can be adjusted relative to the bottom to such an extent that an inlet and/or outlet opening of the combustion chamber, for air and/or fuel, forms between the bottom and the combustion chamber wall.

The bottom 7 can be moved in the direction of the axis by way of an adjusting rod 9, wherein the adjusting rod 9 passes through a passage in a front, second bottom of the combustion chamber. Pressing the set-down sleeve 5 in first tensions a spring and acts on the adjusting rod 9, which in turn displaces the bottom 7. As a result, a volume of the combustion chamber that is sufficient for ignition is first extended. During this movement of the bottom along the combustion chamber wall, condensed water is regularly stripped off. To prevent the mechanism from becoming sluggish, as little water as possible should penetrate into the region of the seal 8 and freeze there.

FIG. 3 shows the seal 8 in an exploded view. The seal 8 comprises a circular first seal ring 21 that extends in the circumferential direction with reference to a cylinder axis 20 of the combustion chamber wall, not shown, having a first interruption 22, as well as a circular second seal ring 23 that also extends in the circumferential direction with reference to the cylinder axis 20, having a second interruption 24. In the assembled state of the combustion chamber, not shown in any detail, the second seal ring 23 lies flat against the first seal ring 21 in the direction of the cylinder axis 20, preferably over its entire circumference that runs around the cylinder axis 20, with the exception of the interruptions 22, 24.

Along the circumferential direction, the first interruption 22 has a first angular position 25, while the second interruption 24 has a second angular position 26. The first angular position 25 and the second angular position 26 form an angle a of 45°. This angle a is fixed in place by a fixation apparatus 27. The fixation apparatus 27 comprises a projection, not shown, on the first seal ring 21, which projects and engages into a recess 28 on the second seal ring, as well as a projection 29 on the second seal ring 23, which projects and engages into a recess in the first seal ring 21, not shown, so that a shape fit occurs between the seal rings 21, 22 in the circumferential direction, in other words a relative movement between the seal rings 21, 22 in the circumferential direction is prevented.

1. A combustion chamber comprising a combustion chamber wall in a form of a hollow cylinder that defines a cylinder axis; a bottom that is adjustable along the cylinder axis within the hollow cylinder relative to the combustion chamber wall; and a seal, which lies against the bottom on the one side of the seal and against the combustion chamber wall on the other side of the seal, in a radial direction with reference to the cylinder axis, wherein the seal comprises a first seal ring that extends in the circumferential direction with reference to the cylinder axis and has a first interruption, and a second seal ring having a second interruption, the second seal ring extending in the circumferential direction with reference to the cylinder axis, wherein the first interruption has a first angular position along the circumferential direction and the second interruption has a second angular position along the circumferential direction, wherein the first angular position and the second angular position form an angle that is greater than 0° and less than 180°.

2. The combustion chamber according to claim 1, wherein the first angular position and the second angular position form an angle that is less than 120°.

3. The combustion chamber according to claim 1, wherein the first angular position and the second angular position form an angle that is greater than 30°.

4. The combustion chamber according to claim 1, wherein the second seal ring follows the first seal ring in an axial direction with reference to the cylinder axis.

5. The combustion chamber according to claim 1, wherein the seal has a fixation apparatus for fixing the angle formed by the first and the second angular position in place.

6. The combustion chamber according to claim 5, wherein the fixation apparatus comprises a projection on the first seal ring and a recess on the second seal ring, wherein the projection projects into the recess.

7. The combustion chamber according to claim 1, wherein the first and/or the second seal ring consist(s) of a hard sealant.

8. The combustion chamber according to claim 1, wherein the bottom has a groove that runs in the circumferential direction, into which the first and/or the second seal ring project(s).

9. The combustion chamber according to claim 1, wherein the combustion chamber comprises an elastic support element, which is disposed between the bottom and the seal in the radial direction, and which biases the first and/or the second seal ring against the combustion chamber wall.

10. The combustion chamber according to claim 1, wherein the bottom can be adjusted relative to the combustion chamber wall in an axial direction with reference to the cylinder axis, to such an extent that an inlet opening and/or an outlet opening of the combustion chamber forms between the bottom and the combustion chamber wall.

11. A fastener driving tool, having a driving piston for driving a fastening element into a work piece, having a combustion chamber in which a propellant can be combusted to drive the driving piston, wherein the combustion chamber comprises a combustion chamber wall in a form of a hollow cylinder that defines a cylinder axis; a bottom that is adjustable along the cylinder axis within the hollow cylinder relative to the combustion chamber wall; and a seal, which lies against the bottom on the one side of the seal and against the combustion chamber wall on the other side of the seal, in a radial direction with reference to the cylinder axis, wherein the seal comprises a first seal ring that extends in the circumferential direction with reference to the cylinder axis and has a first interruption, and a second seal ring having a second interruption, the second seal ring extending in the circumferential direction with reference to the cylinder axis, wherein the first interruption has a first angular position along the circumferential direction and the second interruption has a second angular position along the circumferential direction, wherein the first angular position and the second angular position form an angle that is greater than 0° and less than 180°.

12. The fastener driving tool according to claim 11, wherein the fastener driving tool has a housing and that the combustion chamber wall is rigidly connected with the housing.

13. The fastener driving tool according to claim 11, wherein the fastener driving tool has a housing and that the bottom is rigidly connected with the housing.

14. The combustion chamber according to claim 2, wherein the first angular position and the second angular position form an angle that is less than 90°.

15. The combustion chamber according to claim 14, wherein the first angular position and the second angular position form an angle that is less than 60°.

16. The combustion chamber according to claim 2, wherein the second seal ring follows the first seal ring in an axial direction with reference to the cylinder axis.

17. The combustion chamber according to claim 3, wherein the second seal ring follows the first seal ring in an axial direction with reference to the cylinder axis.

18. The combustion chamber according to claim 2, wherein the seal has a fixation apparatus for fixing the angle formed by the first and the second angular position in place.

19. The combustion chamber according to claim 3, wherein the seal has a fixation apparatus for fixing the angle formed by the first and the second angular position in place.

20. The combustion chamber according to claim 4, wherein the seal has a fixation apparatus for fixing the angle formed by the first and the second angular position in place.
